(19) United States
(12) Patent Application Publication
(10) Pub. No.: US 2019/0212593 A1
(43) Pub. Date: Jul. 11, 2019

(54) LIQUID CRYSTAL DISPLAY AND MANUFACTURING METHOD THEREOF

(71) Applicants: HKC CORPORATION LIMITED, Shenzhen (CN); CHONGQING HKC OPTOELECTRONICS TECHNOLOGY CORPORATION LIMITED, Chongqing (CN)

(72) Inventor: Yu-Jen CHEN, Chongqing (CN)

(73) Assignees: HKC CORPORATION LIMITED, Shenzhen (CN); CHONGQING HKC OPTOELECTRONICS TECHNOLOGY CORPORATION LIMITED, Chongqing (CN)

(21) Appl. No.: 15/553,984

(22) PCT Filed: Feb. 26, 2017
(86) PCT No.: PCT/CN2017/074906

§ 371 Date: Aug. 26, 2017

(30) Foreign Application Priority Data
Nov. 11, 2016 (CN) 201611042807.7

(51) Int. Cl. G02F 1/1341; G02F 1/1339; G02F 1/1362

(52) U.S. Cl. CPC G02F 1/1341; G02F 1/13394; G02F 1/1368; G02F 2001/13415; G02F 1/136209

(57) ABSTRACT

The present application discloses a liquid crystal display, comprising a first substrate and a second substrate, wherein the second substrate is a transistor array substrate, and color filters and photo spacers of the liquid crystal display are both located on the side of the second substrate. The present application further discloses a manufacturing method of a liquid crystal display, wherein the step of the filling the liquid crystal comprises: firstly coating a sealant to a first substrate, and then coating a polyimide film to the first substrate, so that the sealant can block the overland flowing and diffusing of the polyimide film.

### TECHNICAL FIELD

The present invention relates to the technical field of liquid crystal displays, and particularly to a liquid crystal display and a manufacturing method thereof.

### BACKGROUND ART

Regarding liquid crystal displays (LCD), the structure of common thin film transistor-liquid crystal displays (TFT-LCD) is that a liquid crystal cell is placed between two parallel substrates, the second substrate is provided with a thin film transistor array (TFT), and the first substrate is provided with a color filter (CF); and the rotation direction of the liquid crystal molecules is controlled by the changing of the signal and the voltage on the thin film transistor array, to control the emerging or not of the polarized lights at each of the pixel dots, further to realize the displaying.

Due to the developing of liquid crystal displays, the Color Filter On TFT (COT) technique has already been presented maturely, to realize applications with higher requirements. The first substrate of the liquid crystal display is provided with a black matrix (BM) and a polyimide film (PI), and the second substrate of the liquid crystal display is provided with a color filter and a polyimide film. A cylinder lining material, that is, a photo spacer (PS), for maintaining the gap between the liquid crystal units are provided between the first substrate and the second substrate of the liquid crystal display. The first substrate and the second substrate of the liquid crystal display are adhered and sealed by a sealant.

In narrow border frame design of liquid crystal displays, the distance from the display area to the edge is very small, so the design margin of the edge of the sealant area is very small, and the problem of the mutual interfering between the polyimide film and the sealant often happens. However, when the designing of liquid crystal displays employs the Color Filter On TFT structure, it can very conveniently use the photo spacers and the color filters to make a separating wall, to block the polyimide film from outwardly overland flowing and diffusing. Because the adhesion performance of the polyimide film is poor, and thus it cannot withstand the corresponding pulling force of the sealant, the sealant adhered thereto easily suffers from the problem of stripping.

However, along with the upgrading of the manufacturing method, when the manufacturing method of the Color Filter On TFT and the application of the PS on TFT (POT) are combined, the original photo spacers separating wall on the first substrate does not exist any longer. When narrow border products are designed in such a manner, the polyimide film on the first substrate does not have a blocking structure to confine its overland flowing and diffusing, and finally the polyimide film intrudes into the interface between the sealant and the black matrix, which causes the sealant to strip.

All of the conventional manufacturing methods of liquid crystal One Drop Filling (ODF) comprise firstly coating the polyimide film, then coating the sealant, then dropping the liquid crystal, and finally matching and combining into the cell. Therefore, the conventional manufacturing method techniques cannot overcome the problem of the overland flowing and diffusing of the polyimide film.

### SUMMARY OF THE INVENTION

A technical problem that the present invention seeks to solve is: to prevent the sealant stripping caused by the overland flowing and diffusing of the polyimide film to the sealant and the black matrix areas in the narrow border frame design of liquid crystal displays.

Another technical problem that the present invention seeks to solve is: to improve the conventional manufacturing methods of liquid crystal One Drop Filling, overcome the method defect of sealant stripping of liquid crystal displays, and to increase the yield rate of the finished products, and the method has the advantages of simple flow, high efficiency and low cost.

In an embodiment of the present invention, a liquid crystal display comprises a first substrate and a second substrate, wherein the second substrate is a transistor array substrate, and color filters and photo spacers of the liquid crystal display are both located on the side of the second substrate, and the distance between the polyimide film of the first substrate and the sealant is 0. The color filters may comprise first color filters and second color filters, wherein the first color filters are located at a display area of the second substrate, slits are formed between the first color filters, the second color filters are located at an edge of the second substrate and adjacent to the sealant and comprises at least one of a red color filter, a blue color filter or a green color filter, and a slit is not formed at the second color filters.

In an embodiment of the present invention, the polyimide film of the first substrate is stacked in front of the sealant, and a thickness of a tail end of the polyimide film is greater than a thickness of a displaying area end of the polyimide film.

In an embodiment of the present invention, there is provided a manufacturing method of a liquid crystal display, wherein the manufacturing method of a liquid crystal display comprising a step of filling liquid crystal, which comprises: firstly coating a sealant to the first substrate, and then coating a polyimide film to the first substrate, so that the blocking structure layer is formed by the sealant around the first substrate, to block the overland flowing and diffusing of the polyimide film; and firstly coating a sealant to a second substrate, and then coating a polyimide film to the second substrate, wherein the blocking structure layer is formed by the second color filters being around the second substrate and adjacent to the sealant area is the layer of blocking structure, to block the overland flowing and diffusing of the polyimide film.

In an embodiment of the present invention, a liquid crystal display comprises a first substrate and a second substrate, wherein the second substrate is a transistor array substrate, color filters and photo spacers of the liquid crystal display are both located on the side of the first substrate, and the distance between the polyimide film of the second substrate and the sealant is 0.

In an embodiment of the present invention, the polyimide film of the second substrate is stacked in front of the sealant, and a thickness of a tail end of the polyimide film is greater than a thickness of a displaying area end of the polyimide film.

In an embodiment of the present invention, there is provided a manufacturing method of a liquid crystal display, wherein the manufacturing method of a liquid crystal display comprising a step of filling liquid crystal, which comprises: firstly coating a sealant to a second substrate, and then coating a polyimide film to the second substrate, so that blocking structure layer is formed by the sealant around the second substrate, to block the overland flowing and diffusing of the polyimide film; and firstly coating a sealant to a first substrate, and then coating a polyimide film to the first substrate, wherein the blocking structure layer is formed by the color filters being around the first substrate and adjacent to the sealant area is the layer of blocking structure, to block the overland flowing and diffusing of the polyimide film.

In an embodiment of the present invention, the sealant is used to adhere the first substrate and the second substrate, and its material is of non-thermosetting type, or the solidifying temperature of the sealant is higher than the solidifying temperature of the polyimide film.

In an embodiment of the present invention, the polyimide film is spread on the first substrate and the second substrate, and forms a layer of uniform oriented layer, so that the liquid crystal molecules that are located between the two substrates are oriented to have a pretilt angle in a certain direction.

In an embodiment of the present invention, the black matrix is used to block the scan lines and data lines on the first substrate and the second substrate and divide adjacent first color filters.

In an embodiment of the present invention, the photo spacers are used to resist the pressure that is exerted on the liquid crystal panel, and support and maintain the distance between the first substrate and the second substrate.

### Advantageous Effects

The advantageous effects of the present invention are that: the present invention improves the conventional manufacturing methods of liquid crystal One Drop Filling, and can realize preventing the problem of the sealant stripping of the first substrate and the second substrate in the narrow border frame design of liquid crystal displays that combine the manufacturing method of COT and the application of PS on TFT, to increase the yield rate of the finished products, and the method has the advantages of simple flow, high efficiency and low cost.

### BRIEF DESCRIPTION OF THE DRAWINGS

FIG. 1 is the structural diagram of a liquid crystal display that combines the manufacturing method of COT and the application of PS on TFT.

FIG. 2 is the schematic diagram of the step of filling liquid crystal on the first substrate of an embodiment of the present invention.

FIG. 3 is the flow diagram of the step of filling liquid crystal on the first substrate.

FIG. 4 is the structural diagram of a liquid crystal display that combines the manufacturing method of non-COT and the application of non-PS on TFT.

FIG. 5 is the schematic diagram of the step of filling liquid crystal on the second substrate of an embodiment of the present invention.

FIG. 6 is the flow diagram of step of filling liquid crystal on the second substrate.

### DETAILED DESCRIPTION OF THE INVENTION

The descriptions of the following embodiments are intended to by referring to the attached drawings illustrate the special embodiments that can be implemented by the present application. The wordings regarding directions that are mentioned in the present application, such as “upper”, “lower”, “front”, “back”, “left”, “right”, “inner”, “outer”, and “side”, are merely by referring to the directions of the attached drawings. Therefore, the employed wordings regarding directions are intended to illustrate and understand the present application, and not to limit the present application.

The drawings and the description are considered as illustrative in natural, rather than restrictive. In the drawings, elements of the similar structures are indicated by the same reference numbers. Additionally, in order to facilitate the understanding and the describing, the sizes and the thicknesses of the components shown in the drawings are drawn randomly, but the present application is not limited thereto.

In the drawings, for the sake of clarity, the thicknesses of the layers, the films, the panels and the areas are exaggerated. In the drawings, in order to facilitate the understanding and the describing, the thicknesses of some layers and areas are exaggerated. It is understood that, when a component of, for example, the layers, the films, the areas or the substrate is described as “on” another component, the component may be directly on the another component, or there may be an intermediate component.

Additionally, in the description, unless explicitly described otherwise, the word “comprise” will be understood as meaning comprising the component, but not excluding any other component. Furthermore, in the description, “on” means being located above or below the target component, and does not mean that it must be located on the top in the gravity direction.

In order to further illustrate the technical means that are employed by the present application to achieve the predetermined invention object and the effects, the special embodiments, structures, characteristics and effects of the liquid crystal display that is provided by the present application are in detailed described below by referring to the drawings and the preferred embodiments.

In an embodiment of the present application, the sealant is used to adhere the first substrate and the second substrate, and its material is of non-thermosetting type, or the solidifying temperature of the sealant is higher than the solidifying temperature of the polyimide film.

In an embodiment of the present application, the color filters comprise a main body part and a prolonged part, and may comprise first color filters and second color filters. The first color filters are located at a display area of the second substrate. Slits are formed between the first color filters. The second color filters comprise a red color filter, a blue color filter and a green color filter, for presenting multiple colors. Slits are formed between the first color filters. The second color filters are located at an edge of the second substrate and adjacent to the sealant, and comprise at least one of a red color filter, a blue color filter or a green color filter. The second color filters do not have a slit, and may serve as a layer of blocking structure.

In an embodiment of the present application, the polyimide film is spread on the first substrate and the second substrate, and forms a layer of uniform oriented layer, so that the liquid crystal molecules that are located between the two substrates are oriented to have a pretilt angle in a certain direction. The polyimide film may comprise a first polyimide film and a second polyimide film. The first polyimide film is formed on the first substrate. The second polyimide film is formed on the second substrate. The second polyimide film is enveloped by the second color filters, is located on the first color filters, and covers the first color filters. The slits are formed between the first color filters and the slits between the first color filters and the second color filters are filled by the second polyimide film.

In an embodiment of the present application, the photo spacers comprise an upper part and a lower part, and are formed on the second substrate. The lower part of the photo spacers are located on the blue color filter of the first color filters, and is enveloped by the second polyimide film. The upper part of the photo spacers contact with the solid portion of the black matrix of the first substrate, and is enveloped by the first polyimide film, and is used to resist the pressure that is exerted on the liquid crystal panel, and support and maintain the distance between the first substrate and the second substrate.

In an embodiment of the present application, the black matrix is formed between the first substrate and the first polyimide film. The first polyimide film and the sealant cover the black matrix. The black matrix comprises a solid portion and a hollowed-out portion that is adjacent to the solid portion. The solid portion of the black matrix covers scan lines and data lines on the first substrate and the second substrate. The black matrix divides adjacent the first color filters, and its hollowed-out portion is filled by the first polyimide film.

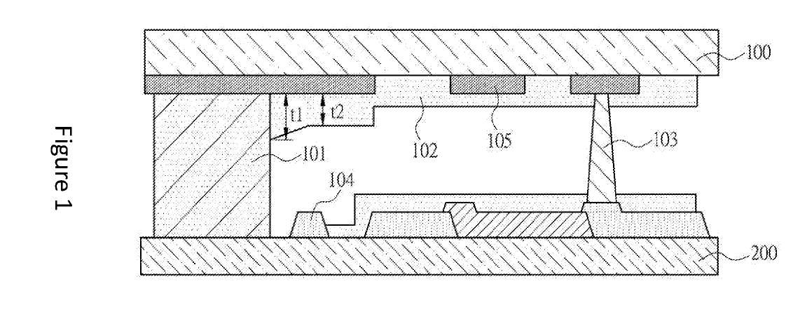

In an embodiment of the liquid crystal display of the present application, the liquid crystal display comprises a first substrate and a second substrate, and the second substrate is a transistor array substrate. As shown in FIG. 1, FIG. 1 is the structural diagram of a liquid crystal panel that combines the manufacturing method of COT and the application of PS on TFT. The photo spacers 103 and the first color filters 104 of liquid crystal display are both located on the side of the second substrate.

When the sealant 101 and the polyimide film 102 of the first substrate 100 are being spread, the sealant 101 is firstly spread, and the polyimide film 102 is then spread. The layout structure of the sealant 101 serves as a separating wall, to block the overland flowing and diffusing of the first polyimide film 102.

In that, the distance between the first polyimide film 102 of the first substrate 100 and the sealant 101 is 0, and the first polyimide film 102 is stacked in front of the sealant 101. The thickness (t1) of the tail end of the first polyimide film 102 is greater than its thickness (t2) at the displaying area end, and the relation between t1 and t2 is t1>t2.

When the sealant 101 and the second polyimide film 102 of the second substrate 200 are being spread, the sealant 101 is firstly spread, and then the second polyimide film 102 is spread. The second substrate 200 is provided with the first color filters 104 at the area adjacent to the sealant 101, and the first color filters 104 may serve as a separating wall, to block the overland flowing and diffusing of the second polyimide film 102.

In that, the distance between the second polyimide film 102 of the second substrate 200 and the first color filters 104 is 0, and the distances between the first color filters 104 and the sealant 101 and between the first color filters 104 and the second color filters are not equal to 0. The black matrix 105 covers the slits between the first color filters 104 and the sealant 101 and between the first color filters 104 and the second color filters.

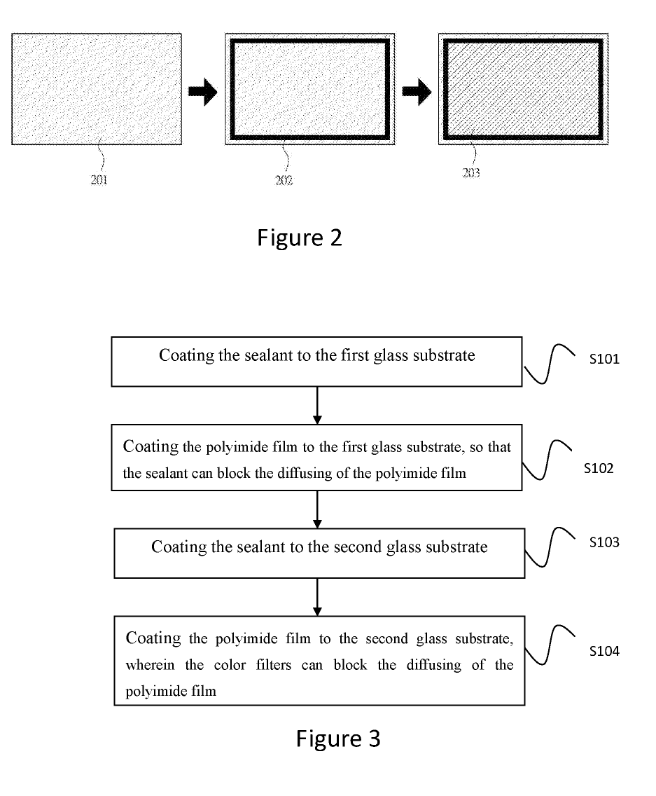

As shown in FIG. 2, wherein FIG. 2 is a schematic diagram of the step of filling liquid crystal on the first substrate, and, referring to the method flow diagrams of steps of filling liquid crystal on the first substrate and the second substrate of FIG. 3, the manufacturing method of One Drop Filling of the present application can prevent the problem of the stripping of the sealant by merely changing the original sequence of the method flow, and the improved steps of liquid crystal One Drop Filling comprises:

Step S101, coating the sealant 202 to the first substrate 201, whereby the blocking structure layer is formed by the sealant 202 itself around the first substrate 201.

Step S102, coating the polyimide film 203 on the first substrate, whereby the polyimide film 203 becomes overland flowing and diffusing to the periphery of the first substrate, till the polyimide film 203 contacts with the sealant 202; the blocking structure of the sealant 202 can block the polyimide film 203 from continuously overland flowing and diffusing; and then the polyimide film 203 is stacked in front of the sealant 202.

Step S103, coating the sealant to the second substrate.

Step S104, coating the polyimide film to the second substrate. The second substrate is provided with the color filters at the area adjacent to the sealant, and the overland flowing and diffusing of the polyimide film can be blocked by using the color filters as a separating wall.

According to such a method, even if the first substrate 201 does not have a corresponding photo spacers or color filters that serves as the separating wall, the present invention can still block the overland flowing and diffusing of the polyimide film 203, by using the sealant 202 instead, to prevent the phenomenon that the sealant 202 gets stripped in narrow border frame design of liquid crystal displays.

Besides the changing in the sequence of the manufacturing method, the material of the sealant is required to be adjusted correspondingly. The material of the sealant must employ a material of non-thermosetting type or a material that has a solidifying temperature higher than the solidifying temperature of the polyimide film. In such a manner, when the polyimide film is being thermally solidified, the sealant can be free from the impact of the solidifying temperature of the polyimide film, and after the method flow of matching and combining the first substrate and the second substrate to form the frame, the solidification reaction of the sealant can be conducted without affecting the structural performance of the display.

In an embodiment of the present application, the present application further comprises a liquid crystal layer, formed within a liquid crystal space that is defined together by the sealant, the first polyimide film, the second polyimide film and the second color filters, and fills the liquid crystal space.

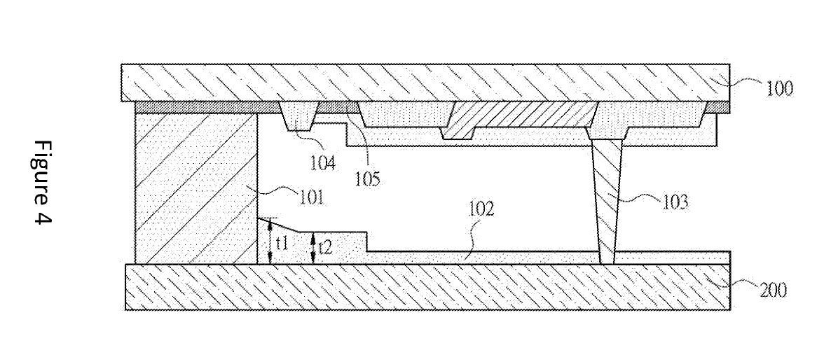

In another embodiment of the liquid crystal display of the present application, when the manufacturing method of non-COT and the application of non-PS on TFT are combined, as shown in FIG. 4, wherein FIG. 4 is the structural diagram of a liquid crystal panel that combines the manufacturing method of non-COT and the application of non-PS on TFT, the color filters 104 and the photo spacers 103 are also located on the side of the first substrate, and the method may be implemented inversely. When the sealant 101 and the polyimide film 102 of the first substrate 100 are being spread, the sealant 101 is firstly spread, and the polyimide film 102 is then spread. The first substrate 100 is provided with the color filters 104 at the area adjacent to the sealant 101, and the color filters 104 may serve as a separating wall, to block the overland flowing and diffusing of the polyimide film 102.

In that, the distance between the polyimide film 102 of the first substrate and the color filters 104 is 0.

When the sealant 101 and the polyimide film 102 of the second substrate 200 are being spread, the sealant 101 is firstly spread, and the polyimide film 102 is then spread. The layout structure of the sealant 101 serves as a separating wall, to block the overland flowing and diffusing of the polyimide film 102.

In that, the distance between the polyimide film 102 of the second substrate 200 and the sealant 101 is 0, and the polyimide film 102 is stacked in front of the sealant 101. The thickness (t1) of the tail end of the polyimide film 102 is greater than its thickness (t2) at the displaying area end, and the relation between t1 and t2 is t1>t2.

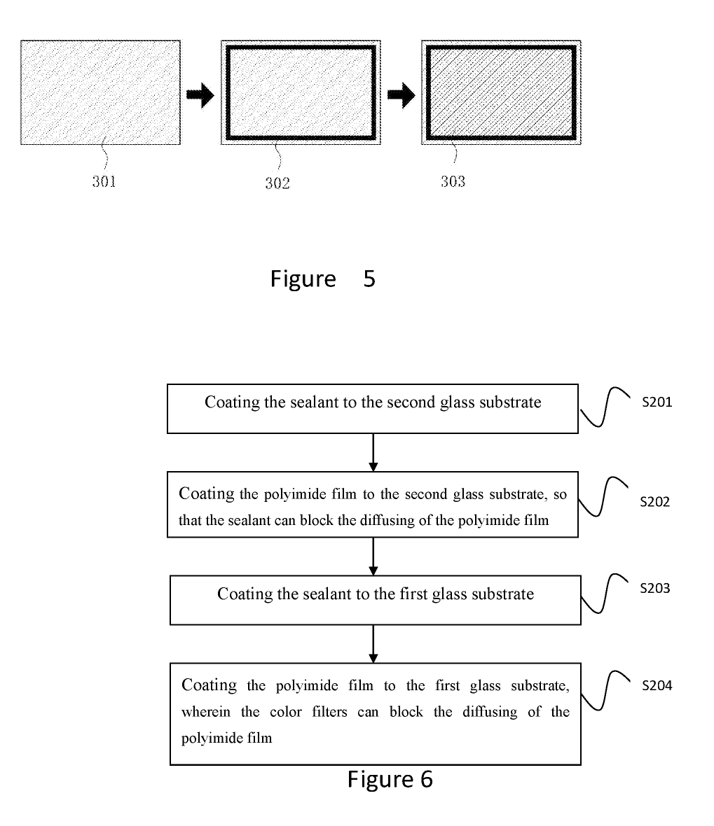

As shown in FIG. 5, wherein FIG. 5 is a schematic diagram of step of filling liquid crystal on the second substrate, and, referring to the method flow diagrams of steps of filling liquid crystal on the first substrate and the second substrate of FIG. 6, which comprises:

Step S201, coating the sealant 302 to the second substrate 301, whereby the blocking structure layer is formed by the sealant 302 itself around the second substrate 301.

Step S202, coating the polyimide film 303 to the second substrate, whereby the polyimide film becomes overland flowing and diffusing to the periphery of the second substrate, till the polyimide film 303 contacts with the sealant 302; the blocking structure of the sealant 302 can block the polyimide film 303 from continuously overland flowing and diffusing; and then the polyimide film 303 is stacked in front of the sealant 302.

Step S203, coating the sealant to the first substrate.

Step S204, coating the polyimide film to the first substrate. The first substrate is provided with the color filters at the area adjacent to the sealant, and the overland flowing and diffusing of the polyimide film can be blocked by using the color filters as a separating wall.

Even if the second substrate 301 does not have a corresponding photo spacers or color filters that serves as the separating wall, the present invention can still block the overland flowing and diffusing of the polyimide film 303, by using the sealant 302 instead, to prevent the phenomenon that the sealant 302 gets stripped in narrow border frame design of liquid crystal displays.

The above embodiments are merely preferred embodiments that are presented to fully illustrate the present application, and are not limiting the present application in any form. Although the present application is disclosed as above by using the preferred embodiments, the protection scope of the present application is not limited thereto. The equivalent substitutions or alternations that are made by a person skilled in the art on the basis of the present application all fall within the protection scope of the present application. The protection scope of the present application is limited by the claims.

What is claimed is:

1. A liquid crystal display, comprising:
a first substrate;
a second substrate; and
a sealant formed between the first substrate and the second substrate;
wherein, color filters and photo spacers are located on a same side of the first substrate or the second substrate.

2. The liquid crystal display according to claim 1, wherein the second substrate is a transistor array substrate.

3. The liquid crystal display according to claim 1, wherein when the color filters and the photo spacers are both located at the second substrate, the liquid crystal display further comprises a polyimide film formed at the first substrate.

4. The liquid crystal display according to claim 3, wherein a distance between the polyimide film and the sealant is 0, and at least a portion of the polyimide film is stacked close to the sealant.

5. The liquid crystal display according to claim 3, wherein a thickness of a tail end of the polyimide film is greater than a thickness of a displaying area end of the polyimide film.

6. The liquid crystal display according to claim 1, the color filters and the photo spacers are both located at the first substrate, the liquid crystal display further comprises a polyimide film formed at the second substrate.

7. The liquid crystal display according to claim 6, wherein a distance between the polyimide film and the sealant is 0, and at least a portion of the polyimide film is stacked close to the sealant.

8. The liquid crystal display according to claim 6, wherein the polyimide film is stacked close to the sealant, and a thickness of a tail end of the polyimide film is greater than a thickness of a displaying area end of the polyimide film.

9. A manufacturing method of a liquid crystal display comprising a step of filling a liquid crystal on a first substrate, wherein the step of the filling the liquid crystal comprises:
coating a sealant to the first substrate; and
coating a polyimide film to the first substrate;
wherein a blocking structure layer is formed by the sealant formed around the first substrate, or is formed by color filters being formed around the first substrate and adjacent to the sealant area.

10. The manufacturing method of the liquid crystal display according to claim 9, wherein when the blocking structure layer is formed by the sealant formed around the first substrate, the step of the filling the liquid crystal further comprises:
coating the sealant to a second substrate; and
coating the polyimide film to the second substrate;
wherein the blocking structure layer is formed by the color filters being around the second substrate and adjacent to the sealant area.

11. The manufacturing method of the liquid crystal display according to claim 10, wherein a material of the sealant is of a non-thermosetting type.

12. The manufacturing method of the liquid crystal display according to claim 10, wherein a curing temperature of the sealant is higher than a curing temperature of the polyimide film.

13. The manufacturing method of the liquid crystal display according to claim 9, wherein when the blocking structure layer is formed by the color filters being formed around the first substrate and adjacent to the sealant area, the step of the filling the liquid crystal further comprises:
coating the sealant to a second substrate; and
coating the polyimide film to the second substrate;
wherein the blocking structure layer is formed by the sealant around the second substrate.

14. The manufacturing method of the liquid crystal display according to claim 13, wherein a material of the sealant is of a non-thermosetting type.

15. The manufacturing method of the liquid crystal display according to claim 13, wherein a curing temperature of the sealant is higher than a curing temperature of the polyimide film.

16. A liquid crystal display, comprising:
a first substrate;
a second substrate;
a sealant formed between the first substrate and the second substrate;
a first polyimide film formed on the first substrate;
a black matrix, formed between the first substrate and the first polyimide film, wherein the first polyimide film and the sealant cover the black matrix, the black matrix comprises a solid portion and a hollowed-out portion being adjacent to the solid portion, the solid portion of the black matrix covers scan lines and data lines on the first substrate and the second substrate, and the hollowed-out portion is filled by the first polyimide film; and
color filters formed on the second substrate, wherein the color filters comprise:
first color filters, located at a display area of the second substrate, wherein the slits are formed between the first color filters, and the black matrix divides adjacent the first color filters thereto; and
second color filters, located at an edge of the second substrate and adjacent to the sealant, and comprising at least one of red color filters, blue color filters or green color filters, the second color filters surround an area adjacent to the sealant to form a blocking structure layer, a distance between the second color filters and the sealant and a distance between the second color filters and the first color filters are not equal to 0, and the black matrix covers the slits between the second color filters and the sealant and the slits between the second color filters and the first color filters, wherein the slits are not formed at the second color filters;
a second polyimide film, formed on the second substrate, wherein the second polyimide film is enveloped by the second color filters, the second polyimide is located on the first color filters and covers the first color filters, and wherein the slits between the first color filters and the slits between the first color filters and the second color filters are filled by the second polyimide film;
photo spacers, comprising an upper part and a lower part, formed on the second substrate, wherein the lower part thereof is located on the blue color filters of the first color filters, and the lower part thereof is enveloped by the second polyimide film, and the upper part thereof contacts with the solid portion of the black matrix of the first substrate, and the upper part thereof is enveloped by the first polyimide film; and
a liquid crystal layer, formed within a liquid crystal space defined together by the sealant, the first polyimide film, the second polyimide film and the second color filters, and the liquid crystal layer fills the liquid crystal space.
